(19) United States
(12) Patent Application Publication
(10) Pub. No.: US 2011/0090885 A1
(43) Pub. Date: Apr. 21, 2011

(54) METHODS AND APPARATUS FOR CENTRALIZED AND COORDINATED INTERFERENCE MITIGATION IN A WLAN NETWORK

(76) Inventor: Saeid Safavi, San Diego, CA (US)

(21) Appl. No.: 12/905,902

(22) Filed: Oct. 15, 2010

Related U.S. Application Data
(60) Provisional application No. 61/252,088, filed on Oct. 15, 2009.

(51) Int. Cl. H04W 4/00

(52) U.S. Cl. 370/338

(57) ABSTRACT

Method and apparatus for interference mitigation in wireless local area networks (such as WLANs). In one embodiment, a centralized interference measurement and mitigation method is disclosed. The method may involve spectral sensing, beamforming, MIMO, power control, MAC scheduling using a cross-layer approach, and/or broadcast channel precoding, employed towards performance enhancement of WLAN networks in presence of interference. In one variant, different actions at interference mitigation are selected based on the source of the interference (e.g., inter-network or intra-network).

### PRIORITY

This application claims priority to U.S. Provisional Patent Application Ser. No. 61/252,088 entitled “METHODS AND APPARATUS FOR CENTRALIZED AND COORDINATED INTERFERENCE MITIGATION IN A WLAN NETWORK” filed Oct. 15, 2009, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates in one exemplary aspect to interference mitigation in wireless networks such as local area networks (WLANs). At least some of the examples disclosed herein relate to a centralized interference measurement and mitigation method involving in one embodiment spectral sensing, beamforming, MIMO, power control, MAC scheduling using a cross-layer approach, and broadcast channel precoding, some or all of which can be employed towards performance enhancement of WLAN networks in presence of interference.

### DESCRIPTION OF THE RELATED ART

Over the few past years, the wireless technology (including e.g., local area network (WLAN) technology) has undergone tremendous evolution. For example, in the case of the WLAN, the evolution has been from low rate data infrared-based communications in first generation WLANs to the high throughput OFDM radios with sophisticated adaptive algorithms including MIMO. As the new technologies evolve, the need for integration of various applications and services become increasingly necessary. For example, today's IEEE 802.11n-based technologies are progressively integrated with the cellular third generation (3G) mobile communication systems to improve the coverage and capacity. It is anticipated that in the near future a superposition (and node co-location) of access networks of various architectures and topologies ranging from pico-cellular systems (such as WPANS) to large cell sized or macro-cellular systems (such as WCDMA and LTE or Long Term Evolution of the UMTS network) covering a wide range of user applications and services. This evolution of wireless networking towards heterogeneous architectures with ubiquitous coverage, imposes yet a higher degree of adaptively and flexibility that can affect the WLAN design and implementation.

In addition to the integration paradigm, due to the growing number of WLAN users on one hand, and the scarcity of spectrum on the other hand, it is anticipated that in the absence of some form of interference management, the interference level (including co-channel interference, adjacent channel interference, co-location interference, etc.) can potentially grow with the scale of future network deployments. Co-location interference is a potentially severe co-channel and/or adjacent interference that exists between co-located devices. Co-located devices are usually two mutually interfering transceivers integrated into a single device and may be co-located on the same circuit board. Co-channel interference in particular is of utmost importance as it can set limits to the performance and spectral efficiencies of wireless networks. This form of interference can be generated by other users belonging to the same network (termed self interference), adjacent uncoordinated networks, or other wireless devices sharing the spectrum in the WLAN's unlicensed bands. Control of co-channel interference is also very important to the network designers and service providers as it determines the size and number of access points in the network, which in turn affects the overall network deployment costs. In addition to co-channel interference, adjacent channel interference can be harmful in some wireless networks, which are sensitive to interference. For example, WLAN devices operating in the lower edge of the 5 GHZ band can interfere with Ultra Wideband (UWB) networks operating at higher edge of the 3.5-4.8 GHz band, especially if they are co-located in the same device. In fact, proper addressing of the adjacent channel interference in co-located radio terminals becomes an important issue that is already attracting the standards development bodies.

This radio channel agility and interference susceptibility along with the scarcity of wireless spectrum motivated a large body of work to optimize the performance of wireless networks. This effort, highly focused on optimization of physical (PHY) layer, resulted in a number of innovative and effective methods for performance improvement of wireless networks. In parallel, advancement in the IC design and integration technologies, resulted in the possibility of employment of complicated receiver algorithms that were initiated by the pioneering works in the 60's and the 70's, but were not feasible to implement until recently. Among the above advancements in the PHY-based radio link techniques, various types of advanced channel coding schemes such as turbo-codes, low-density parity-check codes (LDPC) and other efficient coding schemes have been proposed for WLAN, with a very narrow margin to Shannon capacity (see, e.g. References [1], [2], which are incorporated herein by reference in their entirety). The combination of OFDM (orthogonal frequency division multiplexing) and MIMO (multiple input multiple output)-based multiple antenna systems is yet another important example of highly robust and attractive PHY-based solutions for broadband radio networks (see References [3], [4], which are incorporated herein by reference in their entirety). On the other hand, the time variable nature of mobile wireless networks is effectively addressed by a PHY technique called adaptive modulation and coding (AMC) which dynamically allocates the modulation and coding resources to users, based on their channel condition (or channel state information) (see References [5], [6], which are incorporated herein by reference in their entirety). The interference problem is addressed by a number of MIMO based signal processing algorithms applicable to both uplink and downlink, in addition to the classic interference cancellation methods such as successive interference cancellation (SIC) (see Reference [7], which is incorporated herein by reference in its entirety). Finally a control mechanism that can significantly affect the performance of WLAN networks is the power control which is tightly coupled with both MAC and PHY layers.

In parallel to the information theory-based technologies applied to PHY-based resource allocation, MAC-based resource allocation strategies has also been optimized using a handful of advanced networking techniques In particular an important design aspect of modern WLANs is the support of quality of service or QoS in the MAC. This demand triggered a new generation of MAC protocols in the IEEE 802.11 standards. More specifically, the IEEE 802.11 MAC was initially designed for best effort services, lacked a built-in mechanism for support of the QoS required for real time services such as VoIP, HDTV, online gaming, etc. In order to provide a guaranteed QoS, a new generation of MAC termed IEEE 802.11.e was introduced (see Reference [8], which is incorporated herein by reference in its entirety). This new MAC employs a so called Hybrid Coordination Function (HFC) with two medium access mechanisms and four classes of user priorities that facilitate implementation of a QoS-enabled MAC architecture.

Recently, further enhancement in the design of wireless networks has been enabled through introduction of a new design paradigm, the so-called cross-layer approach which aims at enhancement of the system performance by jointly designing multiple protocol layers (see References [9], [10], which are incorporated herein by reference in their entirety). The main benefit of this approach is that it allows upper layers to better adapt their strategies to varying link and network conditions resulting in extra flexibility helping to improve the network's end-to-end performance. Many recent cross-layer design concepts are based on exploiting multi-user diversity (MUD), the phenomenon of multiple users experiencing independent fading channels. The exploitation of MUD was initially based on the pioneering work presented in Reference [11], incorporated herein by reference in its entirety, for uplink of a single cell. The MUD concept is mainly based on maximizing the sum capacity (defined as the sum of simultaneous user capacities) by scheduling for each time instant, the user (or user group) that has the best channel condition. The gain achieved by this scheme is called MUD gain, which demands a power control law by applying more transmit power to the stronger channels. For downlink scenario a similar optimization concept is used by MUD; i.e., at each time instance the access point (or base station) scheduler assigns transmission to the user with the best channel. These cross-layer methodologies, in effect break the traditional isolation between PRY-based and MAC/DLC-based resource allocation strategies which were historically addressed by the information theory field and networking theory field respectively. This is achieved through a MAC resource allocation strategy supported by knowledge of the channel state information (CSI) provided by the PHY layer.

In addition to the conventional MUD, other degrees of diversity that might appear in a multi-user environment may be exploited to improve the system performance of a WLAN. In particular future networks are anticipated to have a high degree of heterogeneity which includes scenarios like multiservice supporting nodes, multi-standard supporting nodes, single antenna users sharing resources with multiple antenna users, etc. This results in terminals or nodes that require specific methods of exploiting channel conditions, leading to a concept of networks supporting heterogeneous multiuser diversity (HMUD).

These design concepts are particularly useful for supporting delay-constrained applications such as streaming video. However there are still a number of challenges left to be addressed, many of which related to running high QoS services over the unlicensed spectrum assigned to WLANs. For example, in densely populated residential areas such as apartment buildings, WLAN users set their networks completely independent from one another, while the networks can be at close enough proximity to cause severe interference problems. Although the users can select from a number of operating channels, it is still likely that two networks using the same RF frequency be close enough to interfere with each other. In such cases, it is possible that the hidden node problem is not completely addressed by the CSMA/CA and RTS/CTS handshaking mechanisms, resulting in significant throughput degradation. This problem is particularly significant when the radio link traffic has QoS requirements that impose extra sensitivity to each transmission SNR. High speed real time traffics involving image or motion picture communications (e.g. HDTV) are in particular very sensitive to the fading and interference disturbances observed in a wireless network. For example, studies have shown (see Reference [12], incorporated herein by reference in its entirety) that the throughput of the new generation of WLAN (802.11n) supporting live HDTV channels can be significantly reduced (to the extent that the application cannot be supported), if the SNIR is reduced beyond certain threshold (due to the fading and interference effects). In addition, in many scenarios it is known that the radius ratio of the interference region to the transmission region in a node is a function of minimum allowed SNIR, and as the SNIR requirements for specific services (e.g. HDTV) increase, the likelihood of having interference regions beyond the transmission region increases, resulting in the hidden node or uncoordinated interference problems. Interference region of a node can be defined as a region within which the node in receive mode can be interfered by e.g., an unrelated or uncoordinated interferer and suffer a performance loss. Transmission (or communication) region of a node can be defined as a region over which the node can correctly detect data in the absence of interference.

The latest research indicates the need for further optimization in WLAN architecture including strong network management capabilities. This ostensibly promises more efficient networks with access points, switches, and other clients to communicate and cooperate among themselves in an optimized manner by effectively adjusting to the dynamic channel conditions. This effort within the IEEE Part-11 standardization committee is focused on development an extension to 802.11 called 802.11v (see Reference [13], which is incorporated herein by reference in its entirety). The IEEE 802.11v amendment promises to optimize the next generation of WLAN in many aspects. The key elements of this extension include reduction of the radio power consumption through WLAN Network Management Sleep Mode and automatic reduction of the transmitter power when it is not being used. Other important features supported by 802.11v are timing synchronization among nodes, and real time location services (RTLS), which enables mobile device tracking. Finally, one of the most important new features of this extension is a network management approach targeted to improvement of the network reliability and throughput, while improving the co-location interference problem in co-located devices.

Although the latest advancements in WLAN optimization try to further address the interference problem through signaling over network management frames (IEEE 802.11v), they still falls short of addressing the co-channel interference problem globally across a network (or multitudes of networks). This is mainly due to the fact that this standard focuses on the interference from a radio co-location aspect and not directly based on the co-channel interference that may have a different location than the victim radio terminal. On the other hand, it is based on a per-device (e.g., STA) distributed approach, which has two main drawbacks. Firstly, the interference sensing mechanism and accuracy may be limited by the capabilities of the STA, which is relatively restricted. In addition, since it does not follow a centralized approach, the interference scenario is not observed at a global level, and as such is not optimal.

### SUMMARY OF THE INVENTION

Multiple embodiments of the present invention are directed toward systems and methods for further improvement of the throughput and capacity of a wireless communications network. This may be accomplished by, e.g., focusing upon reduction of the interference and in particular the co-channel interference, including the interferences scenarios that are not sufficiently addressed by a standard WLAN network.

In one exemplary aspect, a centralized approach to interference mitigation is disclosed. In one embodiment, the approach introduces a specific node that greatly facilitates the interference measurements and channel state communications to the nodes. Various embodiments detect the receiving or transmitting node interference (i.e. the interference affecting the receiver performance or cause a transmission back off after carrier sensing) at a single node or a set of dedicated nodes in order to avoid or reduce its effect at the victim node. This specialized node, termed Interference Controller Node or ICN, has in some variants communication capabilities with the STAs and AP's, and can be a dedicated access point. This interference detection can be as simple as spectral sensing constituting power measurement and/or can be more sophisticated such as measurements of interference parameters and statistics including bandwidth, duty cycle, hopping sequence, etc, as well as, estimating the link budget of the victim link.

In another aspect of the invention, a method for interference mitigation in a wireless network through use of at least one dedicated node is disclosed. In one embodiment, the at least one node is responsible for addressing the interference within the network, and the method comprising utilizing an interference detection mechanism at the at least one dedicated node.

In one variant, if a victim node's reception and/or transmission are affected by one or more cells of the same network, the method implements an interference correction mechanism.

In another variant, the correction mechanism comprises adjusting one or more parameters of a transmitter of the one or more cells based at least in part on at least one of: (i) one or more interference measurements performed at the dedicated node, and/or (ii) the transmission requirements of the one or more cells.

In yet another variant, the correction mechanism comprises adjusting the transmitter parameters of a node that is then transmitting to the victim node based at least in part on at least one of (i) one or more interference measurements at the dedicated node, and/or (ii) the transmission requirements of the transmitting node.

In still a further variant, the correction mechanism comprises adjusting one or more of the victim node's receiver parameters based at least in part on one or more interference measurements obtained at the dedicated node (e.g., one or more interference mitigation parameters).

In still another variant, if a victim node's reception and/or transmission are affected by one or more nodes of a network other than the network (or by an environmental or non-network based interferer such as a microwave oven or the like), the method implements the interference correction mechanism.

In another variant, the one or more nodes of the other network implement a protocol that the dedicated node supports, and the interference correction mechanism comprises adjusting one or more transmitter parameters of the one or more nodes based at least in part on at least one of: (i) the interference measurements at the dedicated node, and/or (ii) transmission requirements of the one or more nodes.

In a further variant, the interference correction mechanism comprises adjusting the transmitter parameters of a node that is transmitting to the victim node based at least in part on the interference measurements at the dedicated node and transmission requirements of the transmitting node.

In yet another aspect of the invention, apparatus for interference mitigation in a wireless network is disclosed. In one embodiment, the apparatus is disposed at a dedicated node of the network responsible for addressing the interference within the network, and the apparatus comprises apparatus configured to utilize an interference detection mechanism at the at least one dedicated node.

In one variant, the apparatus further comprises: logic configured to, if a victim node's reception and/or transmission are affected by one or more cells of the same network, implement an interference correction mechanism; and apparatus for interference correction.

In another variant, the apparatus for correction comprises apparatus configured to cause adjustment of one or more parameters of a transmitter of the one or more cells based at least in part on at least one of (i) one or more interference measurements performed at the dedicated node, and/or (ii) the transmission requirements of the one or more cells.

In still a further variant, the apparatus for correction comprises apparatus configured to cause adjustment of one or more of the transmitter parameters of a node that is then transmitting to the victim node based at least in part on at least one of (i) one or more interference measurements at the dedicated node, and/or (ii) transmission requirements of the transmitting node.

In another variant, the apparatus for correction comprises apparatus configured to cause adjustment of one or more of the victim node's receiver parameters based at least in part on one or more interference measurements obtained at the dedicated node.

In yet another variant, the apparatus further comprises logic configured to, if a victim node's reception and/or transmission are affected by one or more nodes of a network other than the network, implement the interference correction mechanism.

In another variant, the one or more nodes of the other network implement a protocol that the dedicated node supports, and the interference correction mechanism comprises logic to cause adjustment of one or more transmitter parameters of the one or more nodes based at least in part on at least one of: (i) the interference measurements at the dedicated node, and/or (ii) transmission requirements of the one or more nodes.

In another aspect of the invention, an interference-mitigating wireless network architecture is disclosed. In one embodiment, the architecture comprises: at least one dedicated node responsible for addressing the interference within the network; at least one interference detection mechanism at the at least one dedicated node; and an interference correction mechanism in communication with the at least one detection mechanism. The detection and correction mechanisms cooperate to mitigate interference at a victim node within the network.

In another aspect of the invention, a computer-readable apparatus is disclosed. In one embodiment, the apparatus comprises a storage medium with at least one computer program disposed thereon, the at least one program configured to detect and cause mitigation of interference within one or more other nodes of the network.

In another aspect of the invention, a method of operating a wireless network is disclosed. In one embodiment, the method comprises designating one or more nodes within the network as interference mitigation nodes, and operating these nodes so as to detect and cause mitigation of interference at other “victim” nodes within the network by controlling at least one parameter at one or more interfering nodes within or external to the network.

These and other aspects of the invention shall become apparent when considered in light of the disclosure provided herein.

### BRIEF DESCRIPTION OF THE FIGURES

The invention described herein, is detailed with reference to the following figures. The attached drawings are provided for purposes of illustration only and only depict examples or typical embodiments of the invention. It should be noted that the illustrated regions are just examples and regions can take any shape. Also, it should be noted although illustrations are shown in 2D; in general, the zones are three dimensional. It also should be noted that for clarity and ease of illustration these drawings are not necessarily made to scale.

FIG. 1 is a tree diagram illustrating an example hierarchy of the proposed centralized interference mitigation techniques 100, including possible methodologies and the steps in each approach. It includes two main branches for interference mitigation, namely, interference source based 112, and interference victim based 120 methodologies comprising a high level illustration of the interference correction techniques proposed herein.

FIG. 2 shows an example block diagram for the apparatus proposed in this invention, as well as its network interfaces. An ICN device 220 is shown at two different levels of interfaces, namely, the PRY 230 (physical layer), the MAC & DLC 222 (Media Access Control and Data Link Layer). The Figure also shows an example AP 200 and its wireline infrastructure based interface 256 with the ICN.

FIG. 3 graphically illustrates an example of an interference scenario with a victim node UT(a)1 316 belonging to the cell (a) 310, administrated by the access point AP(a) 314. The interference is a self interference caused by a neighboring cell (b) 300 of the same network, due to a beamforming targeted to a user terminal UT(b)1, 306.

FIG. 4 graphically illustrates the same network as in FIG. 3, but after application of an exemplary antenna pattern adaptation algorithm (114 in FIG. 1) which employs an interfering transmitter antenna pattern adaptation for interference mitigation.

FIG. 5 graphically depicts the exemplary network similar to the networks in FIGS. 3 and 4, but with an extra interferer 542 with a range that can affect a new node in cell (a), i.e. UT(a)3 532.

FIG. 6 graphically illustrates the same network as in FIG. 5, but after a so-called “Link Tx-Based”, “Interference Victim Based” algorithm which employs transmitter antenna pattern adaptation (128 in FIG. 1) for interference mitigation takes place.

### DETAILED DESCRIPTION OF THE INVENTION

This invention is targeted at inter alia addressing the harmful effect of interference, and in one particular aspect, co-channel interference when implementation of the conventional methodologies are not possible, not effective, inefficient and/or insufficient (e.g. for support of the application's QoS requirements, etc.), or whenever the effectiveness of these techniques can be further enhanced. There are in fact a number of likely implementation scenarios that could result in these situations.

As used herein, the STA (station) is used to refer to a device that has the capability to use the IEEE 802.11 protocol including MAC and PHY (e.g. a PC, a laptop, PDA etc.). However, from the network topology point of view, the Station is the infrastructure mode of the wireless device which enables connection with the Access Point. A Station, a node, and a client may be used interchangeably depending on the context. Note however that the invention is in no way limited to 802.11 networks or equipment, or even WLANs for that matter. The WLAN embodiments described herein are merely exemplary of the broader principles of the invention.

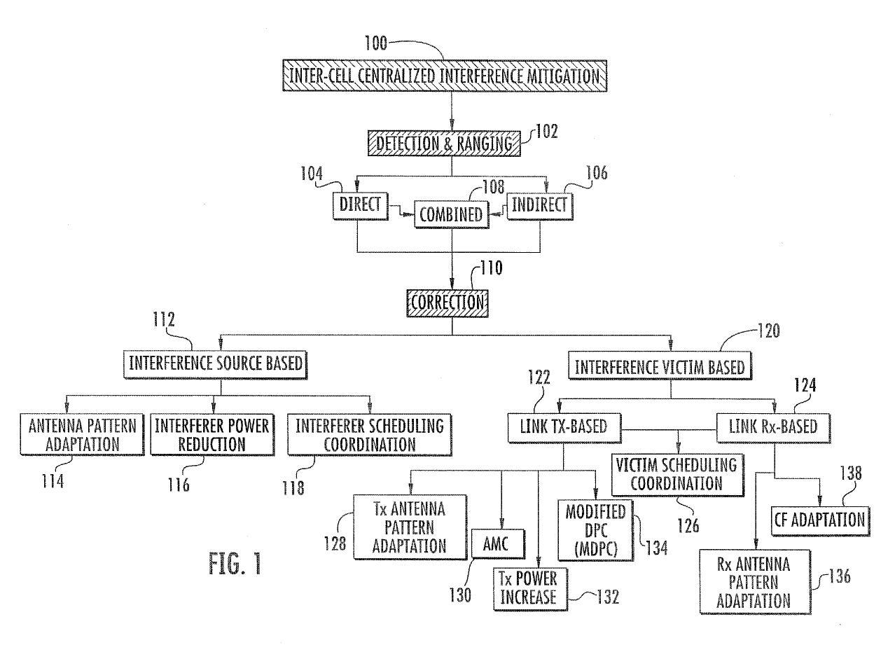

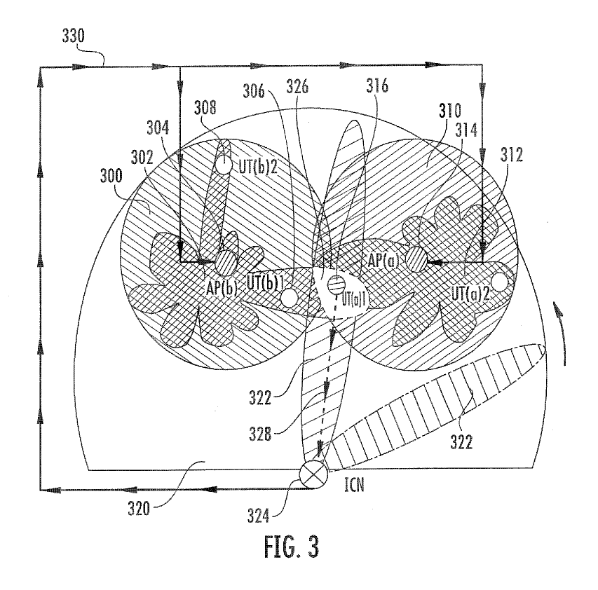

The interference mitigation process can be divided into two steps:
Interference Detection: This involves the process of ranging (or tracking) to locate the network nodes, and sensing, detection and/or characterization of the interference power source (as labeled in FIG. 3, 336) which is categorized into direct, indirect and combined interference detection.
Interference Correction: It includes all the actions necessary to reduce or cancel the interference effect.
Direct Interference Detection: In some embodiments the interference affecting the network nodes which could consist of UTs and/or APs, is directly detected at the ICN central node (FIG. 1, 104). In some embodiments both UTs and APs are considered for ICN-assisted interference mitigation. In other embodiments, depending on the application, either UTs or APs are considered for the ICN-aided interference mitigation. In some embodiments the interferer parameters are detected by a simple spectral sensing including estimation of power and bandwidth of the signal. In other embodiments, in addition to the spectral sensing, other characteristics of the signal are collected including the signal statistics. Prior to interference mitigation and upon power up, the ICN tries to connect to its service area nodes (e.g., nodes that are assigned to a specific ICN) to establish information about the relative location of each network node within its range. This connection can be performed through the wireless link or if possible through the infrastructure connecting the APs. For example in the modern WLAN architectures supporting the IEEE 802.11v (see Reference [13], which is incorporated herein by reference in its entirety). Network management, the ranging can be performed through the network management protocol over the wired infrastructure connecting the APs. For earlier version of the WLAN standards, ranging can be established through well-studied signaling strategies proposed for WiFi ranging (see, e.g. References [14], [15], which are incorporated herein by reference in their entirety). Note that the location information of network nodes helps the ICN to predict the interference power (or other characteristics) as seen by the victim terminal (e.g. by applying specific path loss and/or multipath channel statistical models and computing link budgets).

Indirect Interference Detection: In this approach (FIG. 1, 106) the interference is not directly detected at the ICN node. Instead, the existence of an interferer source and its characteristics such as power level can be established indirectly through close monitoring of the interference parameters such as SNIR of the network nodes (AP, UT or both nodes may be considered for these measurements). In some embodiments this monitoring information can be obtained from the victim node through for example a feedback channel or network management protocols and then updated based on ranging and transmission data for each node, as well as, propagation characteristics of the environment. In some embodiments, prior to interference mitigation and upon power up, the ICN connects itself to the network to establish information about the relative location of each network node within its range (as mentioned above). For example in WLAN this can be established through signaling strategies proposed for ranging (e.g. [14], [15]) or using the IEEE 802.11v protocols [13]. It is noted that for indirect interference detection, this location finding strategy is not mandatory and is usually employed if the ICN would require the knowledge of victim link budget in the correction phase and/or when other interference related parameters such as BER or other quality metric estimations are required. Once the location of nodes is established the SNIR and/or other interference parameters for each node are measured, they will be stored in the ICN in association with each node location. In some other embodiments location finding step is unnecessary and the interference indicators such as SNIR measurement are obtained through a fast feedback channel communicating the value measured at the receiver of the network node back to the ICN (in many WLAN architectures, this can be through the RTS/CTS handshake). In some other embodiments the interference parameters can be indirectly obtained by the ICN through the network management protocols. In some embodiments, this SNIR (and/or other parameter(s)) can be averaged over a sliding sample window with a size determined by the expected coherence time of the channel. Once the variations of the SNIR (and/or other parameter(s) such as number of erroneous packets) are consistently above certain threshold, the ICN concludes that an interferer is affecting the network node.

Combined Interference Detection: Some embodiments may use a combined interference detection approach (FIG. 1, 108). This strategy can help avoiding unnecessary false alarms and speedup the feedback channel information. For example in some embodiments, the interference power at the victim receiver can be initially obtained by a direct measurement and then using the ranging data it can be recomputed as the node moves across the network.

Interference Correction: Once the interference is detected and its parameters of interest are verified, the ICN can deploy either or both of the following strategies:
I. Interference Source Based (ISB): When the interference is generated by a node that the ICN can communicate with, such as self interference generated by the adjacent cells of the network (AP or UT), the ICN may request the interfering node to adjust its transmission such that its harmful effect on the victim receiver is removed or reduced (FIG. 1, 112). This may include but not limited to adjustment of antenna patterns (antenna pattern adaptation, 114), rescheduling the interferer transmission to avoid interfering with the victim node (interferer scheduling coordination, 118) and/or reduction of the transmission power (interferer power reduction 116), when possible. This approach can be applied to an inter-cell scenario (interference generated by the AP or UT of neighboring cell) or an intra-cell scenario (interference generated within the victim cell, such as co-located radio interference).
II. Interference Victim Based (IVB): This approach (FIG. 1, 120) can be applied to inter-cell and intra-cell interference scenarios. In this approach the radio link performance of the victim node is improved by addressing the data transmitter node or the receiver node, or both, as defined below:
   a. Link Transmitter Based: The transmitter based approach I (link Tx-based, 122) includes, but not limited to, improving the link budget by adjusting the transmitting node's power (Tx power increase, 132), antenna pattern (Tx antenna pattern adaptation, 128) and/or, adjustment of the transmitting node's scheduling algorithm to adapt to the new interference scenario (Victim scheduling coordination, 126, if the scheduler lies in the transmitter). When an AP is using precoding in such as Dirty Paper Coding (DPC) (see Reference [16], which is incorporated herein by reference in its entirety) during broadcasting to the UTs that includes the victim node, the precoding scheme can be adapted to the interference scenario by incorporating the new channel state information (CSI) to the precoding algorithm (modified DPC, 134). Another example of the transmitter based interference mitigation is to readjust the adaptive modulation and coding parameters (AMC, 130) to match the link budget variation due to the interference.
   b. Link Receiver Based: In some embodiment interference parameters (e.g. its statistics, bandwidth, duty cycle, etc.) is communicated to the victim receiver (link Rx-based, 124) to help the victim node adjusts its interference mitigation strategy and/or parameters locally. To reduce the messaging signaling overhead, in some other embodiments, the interference parameters are processed at the interference measuring node (ICN) and a set of interference mitigation parameter updates are communicated to the victim node (directly or through the cell's AP). These parameters include but are not limited to coordination function parameters (CF adaptation, 138) and the receiver antenna pattern (Rx antenna pattern adaptation, 136). For example in a CSMA/CA WLAN the interference statistics data can be processed at the ICN to change the default parameters of the receiving node's CSMA/CA. This includes a number of possible parameters such as the back off window size definition for the receiver, and/or its max/min values based on the access point interference detection and/or its prediction. On the other hand, when a QoS-based MAC is supported (e.g. the HCCA or Hybrid Coordination Function) Controlled Channel Access used in 802.11e [8]), the user priority parameters may be adjusted to the scenario. Finally interference mitigation can be accommodated by adjustment of the scheduling algorithm at the receiving node to the new interference scenario (Victim scheduling coordination, 126, if the scheduler lies in the receiver).

In some embodiment the whole network or a part of the network (represented by a number of cells in a cellular network) is served by the ICN. We name this configuration as “inter-cell interference mitigation”. In some other embodiments the ICN is dedicated to the interference reduction in a set of networks in a specific geographical area. We name this configuration as “inter-network interference mitigation”. The following gives detail examples of the apparatus and its connectivity, as well as an implementation of some of the above interference mitigation methodologies in a WLAN environment.

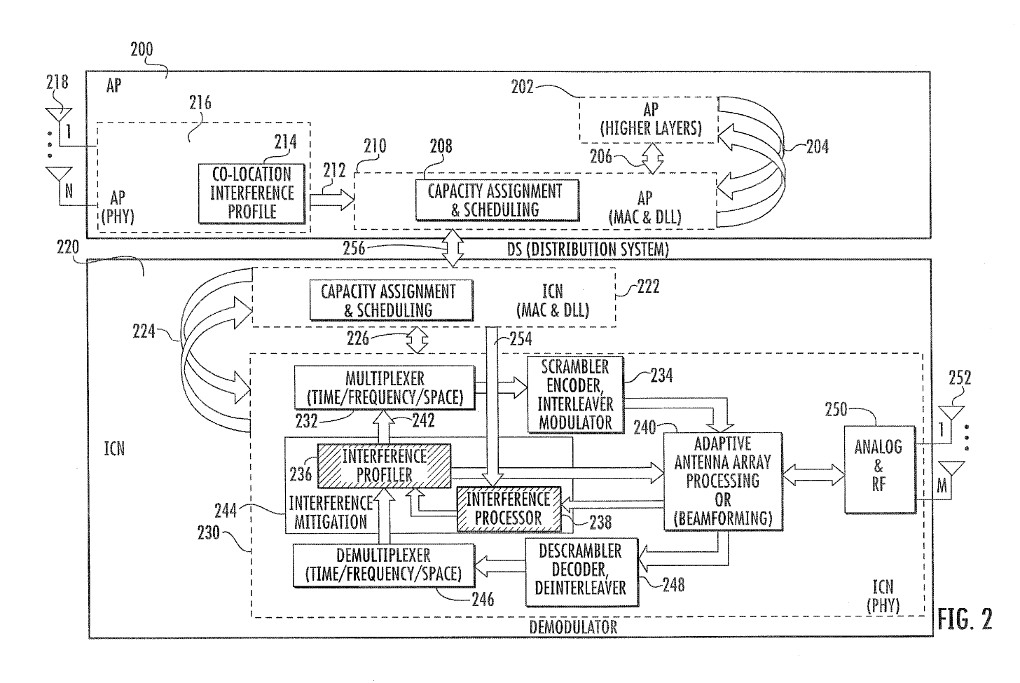

Apparatus Example Block Diagram: FIG. 2 depicts an example block diagram for the apparatus proposed in this invention, i.e. the Interference Controller Node (ICN) device 220 and its connection example to the WLAN network. The device is shown at two different levels namely, the PHY 230 (physical layer), the MAC & DLC 222 (Media Access and Data Link Control Layers). The link 224 shows the “cross-layer” connection between the ICN PHY 230 and its MAC/DLC 222, while 226 indicate the standard layer interfaces based on the OSI (open system interconnect) model. FIG. 2 also illustrates a network connection example between the ICN and an AP 200 (the “victim AP”), based on the wired infrastructure used in WLAN. In IEEE 802.11 terminology, this infrastructure is called distribution system or (DS). The interface 256 carries the network management traffic (e.g. based on the IEEE 802.11v amendment [13]). The AP 200 is also shown in terms of its PHY 216 and MAC 210 layers. In addition the higher layers 202 in AP (such as Network, Session Presentation and Application layers) is shown with an optional cross layer connectivity 204 to the MAC&DLL 210 along with the standard ISO interface 206. It is assumed that the AP PHY has other co-located interfaces in its radio causing a co-location interface as addressed by the IEEE 802.11v standard. The behavior of such interference(s) is processed in the PHY module and through a co-location interface profile unit 214 is translated to a format that MAC can receive (through the interface 212). The ICN PHY layer constitutes of some standard transceiver blocks at the baseband digital, analog, and RF levels. The interference mitigation module 244 is responsible for detection of the interference, as well as, interference correction including support of the processing and the data exchange required for interference correction as stated above. For example in an inter-cell direct interference mitigation scenario the cross-layer connection may be used to aid the victim AP interference mitigation, by adjusting the scheduling at the MAC level. More specifically, during interference detection the receiver of ICN in FIG. 2 detects the interference parameters such as power, with desired sensitivity/accuracy (e.g. using smart antenna techniques in 240). This information is passed to the interference processor 238, which can perform different computations on the received signal such as its energy, waveform, etc., depending on the type of interference and its statistics. In the simplest scenario the interference processor measures the in-band RSSI (Received Signal Strength Indicator) of the interferer (or its SNIR at the victim node) and communicates this information to the interference profiler block 236. The interference profiler in turn processes this information and translates it to a signal protocol that through a cross-layer connection can eventually update the resource allocation strategy used in the MAC module of the STA 210, through the ICN MAC module 222 and the DS connection 256. In a more complicated scenario the interference processor may process the signal spectrum, statistics, duty cycles, etc., and translate this information to a form that can be used by the scheduler according to a specific QoS constraint. The combination of interference processor and interference profiler constitutes the interference mitigation block 244. In some embodiments the co-location interference information is also added in the interference profile through the DS interface 256 from the AP MAC to ICN MAC and then through the connection 254 is incorporated to the interference processor 238. Note that although the AP in FIG. 2 refers to the victim node, it can also be the interfering node as described above. In addition, the ICN may establish connectivity to other APs, as will be described below.

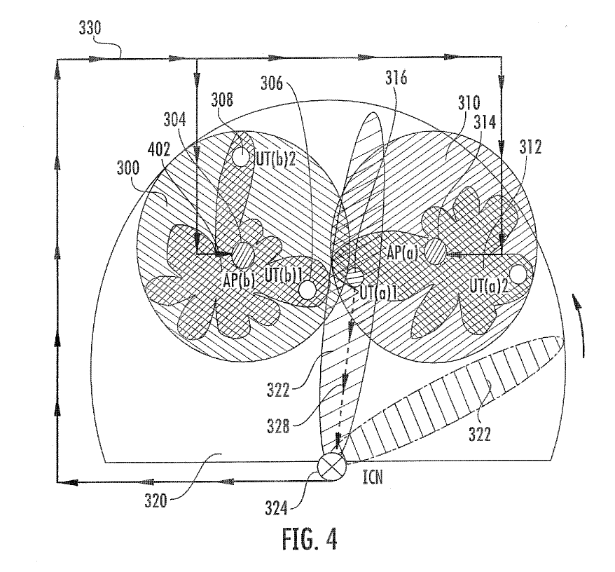

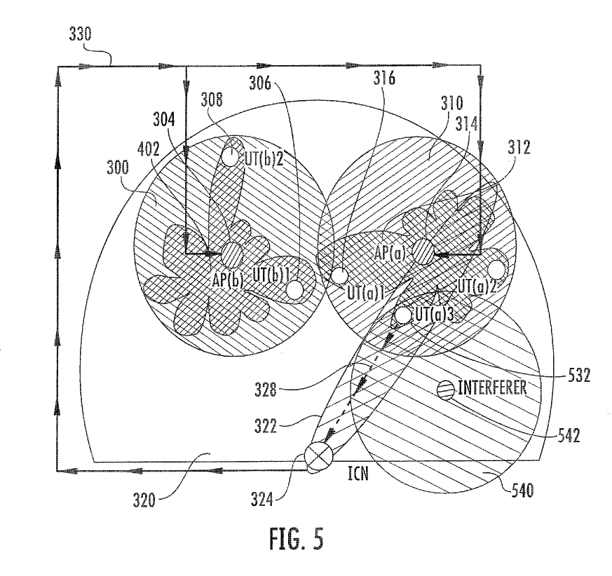

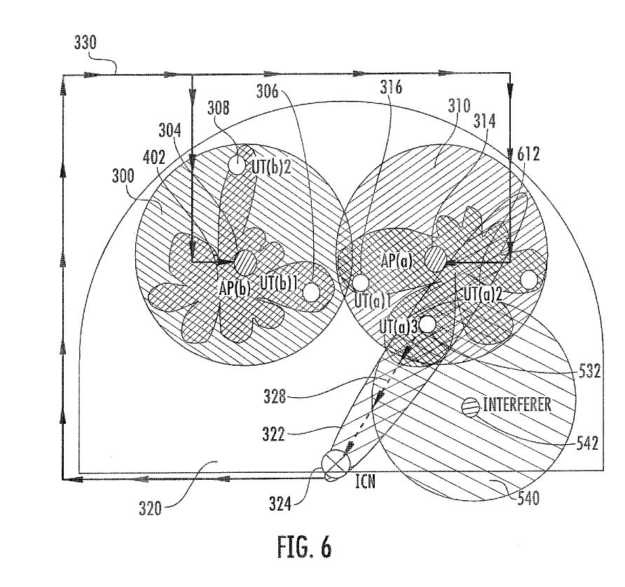

Examples of Interference Mitigation Scenarios Using a Centralized Strategy.
I. Interference Source. Based. Scenario Example: FIG. 3 shows an example of an interference scenario with a victim node UT(a)1 316 belonging to the cell (a) 310, administrated by the access point AP(a) 314. The figure shows that an ICN 324, using a beam scanning technique, can detect the interference and obtains its information through a wireless link 328. The ICN (being for example a device similar to FIG. 2 block diagram) processes this information and communicates them through a WLAN distribution system (DS) interface 330, to either or both access points. The interference is a self interference caused by a neighboring cell (b) 300, due to a beamforming targeted to a user terminal UT(b)1 306 which also penetrates interference signal into the UT(a)1 316. The figure shows that an ICN 324, uses a beam scanning technique (e.g. beam switching such as Butler Matrix or through an adaptive antenna system, AAS) to detect the interference, and in one embodiment obtains the interference parameters through a wireless link 328, although other types of links may be used. The ICN 324 (being for example a device similar to 220 in FIG. 2) processes this information and communicates them through a distribution system (DS) 330, to either or both cell's access points (AP(a) 314 and AP(b) 304). Without loss of generality in this example we assume that the DS runs an IEEE 802.11v protocol. Note that in FIG. 3 both cells are assumed to show antenna patterns referring the time that the interference is detected. FIG. 4 shows exactly the same network as in FIG. 3, but after a so called “Antenna Pattern Adaptation”, “Interference Source Based” algorithm (114 in FIG. 1) which employs transmitter antenna pattern adaptation for interference mitigation. Here the interfering antenna pattern in cell (b) 400 is adjusted so that it does not harm the user terminal UT(a)1 416 in cell (a) 410.
II. Interference Victim Based Scenario Example: FIG. 5 depicts the network similar to the networks in FIGS. 3 and 4, but with an extra interferer 542 with a range that can affect a new node in cell (a), i.e. UT(a)3 532. In this example the victim node is not affected by a neighboring cell, but rather with a foreign interferer, that the ICN can analyze, but cannot establish a connection (e.g. a different standard, or an unauthorized node). The figure shows that an ICN 524, employs a beam scanning technique, examples of which is given above, to detect the interference and obtain its parameters through a wireless link 528. The ICN 524 (being for example a device similar to 220 FIG. 2) processes this information and communicates them through a distribution system (DS) 530, to the victim cell's access point AP(a) 514 in order to adjust its interference mitigation and for MAC scheduling parameters, including but not limited to, increasing the Tx power, changing the antenna pattern, increasing the back off window, adjusting the HCCA parameters [8], etc. Without loss of generality this example we assume that the DS runs an IEEE 802.11v protocol [13]. Note that the both cells are assumed to show the antenna patterns that refer to the time that the interference is detected. FIG. 6 shows exactly the same network as in FIG. 5, but after a so called “Link TX-Based”, “Interference Victim Based” algorithm which employs transmitter antenna pattern adaptation (128 in FIG. 1) for interference mitigation has taken place. Here the interfering antenna pattern in cell (a) 610 is adjusted to enhance the link budget of the victim node, to the extent that the UT(a)3 632 is not disturbed by the interference, or the interference effect is reduced to an acceptable SNIR.

Note that without loss of generality, in the above examples, we assume that the IEEE 802.11v network management standard [13] is running over the distribution system (DS). When this standard protocol is used, the interference profiles (e.g. combination of the interference profiles measured by the ICN and the co-located interference) can be easily communicated across the network STAs using especial fields proposed for co-located interference. These fields transmitted on the so called interference frame [13] include many informative fields including interference report period, interference type (index or identifier), frequency domain fields (including interference level, power, bandwidth, carrier frequency, etc), time domain fields (such as interference period, start time), etc.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

### APPENDIX I—REFERENCES

All references listed below are incorporated by reference herein in their entirety.
[1] J. Tousch, M-H. Hamon and J. Benko, “Turbo-Codes Complexity Estimates”, IEEE 802.11n Proposal 1385-r1, November 2004.
[2] H. Zhong, and T. Zhang, ‘Block-LDPC: A Practical LDPC Coding System Design Approach’, IEEE Trans. on Circ. And Syst.-I: Reg. Papers, Vol. 52, N. 4, April 2005.
[3] Allert Van Zelst, Tim Schenk, “Implementation of a MIMO OFDM-Based Wireless LAN System, IEEE Trans. on Sign. Proc., Vol. 52, pp. 483-494, 2004.
[4] Molisch, A. F., “A Generic Model for MIMO Wireless Propagation Channels in Macro- and Micro Cells”, IEEE Transactions on Signal Processing, ISSN: 1053-587X, Vol. 52, Issue 1, pp. 61-71, January 2004
[5] Minsheok Choi Jinyoung Oh Youngnam Han “Congestion Control based on AMC Scheme for WLAN Mesh Networks,” IEEE 18th International Symposium on Personal, Indoor and Mobile Radio Communications, 2007. PIMRC 2007. September 2007, pp. 1-5.
[6] Fei Peng Jinyun Zhang Ryan, W. E., “Adaptive Modulation and Coding for IEEE 802.11n,” Wireless Communications and Networking Conference, 2007.WCNC 2007, March 2007, pp. 656-661.
[7] W. Wolniansky et al, “V-BLAST: An architecture for realizing very high data rates over the rich-scattering wireless channel,” Proc. ISSSE, Pisa, Italy, September 1998.
[8] Part 11: Wireless LAN Medium Access Control (MAC) and Physical Layer (PHY) specifications, Amendment 8: Medium Access Control (MAC) Quality of Service Enhancements (IEEE 802.11e standard).
[9] L. Georgiadis, M. J. Neely and L. Tassiulas, “Resource Allocation and Cross Layer Control in Wireless Networks,” New Publishers Inc., 2006.
[10] Q. Liu et al, “Cross-layer modeling of adaptive wireless links for QoS support in heterogeneous wired-wireless networks,” ACM/Kluwer Journal of Wireless Networks (WINET), Vol. 12, pp. 427-437, May 2006.
[11] R. Knopp and P. A. Humblet, “Information capacity and power control in single-cell multiuser communications,” Proc. IEEE ICC, June 1995.
[12] Tim C. W. Schenk, Guido Dolmans and Isabella Modonesi, “Throughput of a MIMO OFDM based WLAN system,” Proc. Symposium IEEE Benelux Chapter on Communications and Vehicular Technology, 2004 (SCVT2004), Gent, Belgium, November 2004.
[13] Part 11: Wireless LAN Medium Access Control (MAC) and Physical Layer (PHY) specifications, Amendment 8: Wireless Network Management (IEEE 802.11v standard).
[14] Z. Xiang, S. Song, J. Chen, H. Wang, J. Huang, X. Gao “A wireless LAN based indoor positioning technology,” IBM J. RES. & DEV. VOL. 48 NO. 5/6 SEPTEMBER/NOVEMBER 2004
[15] M. Ciurana, F. Barcelo-Arroyo and F. Izquierdo, “A ranging method with IEEE 802.11 data frames for indoor localization,” WCNC 2007 proceedings, 2007.
[16] M. Costa “Writing on dirty paper”. IEEE Trans. Information Theory, Vol. 29, pp. 439-441, May 1983.

What is claimed is:

1. A method for interference mitigation in a wireless network through use of at least one dedicated node responsible for addressing the interference within said network, the method comprising utilizing an interference detection mechanism at said at least one dedicated node.

2. The method of claim 1, further comprising if a victim node's reception or transmission are affected by one or more cells of the same network, implementing an interference correction mechanism.

3. The method of claim 2, wherein said correction mechanism comprises adjusting one or more parameters of a transmitter of said one or more cells based at least in part on at least one of (i) one or more interference measurements performed at the dedicated node, and/or (ii) the transmission requirements of the one or more cells.

4. The method of claim 2, wherein said correction mechanism comprises adjusting the transmitter parameters of a node that is then transmitting to the victim node based at least in part on at least one of: (i) one or more interference measurements at the dedicated node, and/or (ii) the transmission requirements of the transmitting node.

5. The method of claim 2, wherein said correction mechanism comprises adjusting one or more of said victim node's receiver parameters based at least in part on one or more interference measurements obtained at the dedicated node.

6. The method of claim 5, wherein said one or more receiver parameters comprise one or more interference mitigation parameters.

7. The method of claim 2, further comprising if a victim node's reception or transmission are affected by one or more nodes of a network other than said network, implementing said interference correction mechanism.

8. The method of claim 2, further comprising if a victim node's reception or transmission are affected by one or more devices not associated with said network, implementing said interference correction mechanism.

9. The method of claim 7, further comprising, wherein said one or more nodes of said other network implement a protocol that the dedicated node supports, and the interference correction mechanism comprises adjusting one or more transmitter parameters of the one or more nodes based at least in part on at least one of: (i) the interference measurements at the dedicated node, and/or (ii) transmission requirements of said one or more nodes.

10. The method of claim 8, further comprising, wherein said one or more nodes of said other network implement a protocol that the dedicated node supports, and the interference correction mechanism comprises adjusting one or more transmitter parameters of the one or more nodes based at least in part on at least one of: (i) the interference measurements at the dedicated node, and/or (ii) transmission requirements of said one or more nodes.

11. The method of claim 7, wherein the interference correction mechanism comprises adjusting the transmitter parameters of a node that is transmitting to the victim node based at least in part on the interference measurements at the dedicated node and transmission requirements of the transmitting node.

12. The method of claim 8, wherein the interference correction mechanism comprises adjusting the transmitter parameters of a node that is transmitting to the victim node based at least in part on the interference measurements at the dedicated node and transmission requirements of the transmitting node.

13. The method of claim 7, wherein the interference correction mechanism comprises adjusting at least one of the victim node's parameters based at least in part on the interference measurements at the dedicated node and transmission requirements of the victim node.

14. The method of claim 8, wherein the interference correction mechanism comprises adjusting at least one of the victim node's parameters based at least in part on the interference measurements at the dedicated node and transmission requirements of the victim node.

15. The method of claim 1, further comprising detecting at the dedicated node by expanding a carrier sensing range.

16. The method of claim 1, further comprising estimating, at the dedicated node, a level of interference.

17. The method of claim 2, further comprising:
detecting at the dedicated node an interference at another network node by receiving the characteristic of the interference measured at the victim node through a WLAN air interface; and
communicating back to the transmitter through a feedback channel.

18. The method of claim 2, wherein said dedicated node detects interference by receiving a characteristic of the interference measured at the victim node through a WLAN air interface.

19. The method of claim 1, wherein the dedicated node controls an effect of said interference by providing an interferer node with information to adjust its transmission power to minimize said interference effect.

20. The method of claim 1, wherein the dedicated node controls an effect of said interference by providing an interferer node with information to adjust scheduling in at least one of a time, a frequency and/or a space domains to minimize said interference effect.

21. The method of claim 2, wherein the dedicated node controls an effect of said interference by providing a transmitter of the victim node with information enabling said transmitter to increase its transmitter power to minimize said interference effect.

22. The method of claim 2, wherein the dedicated node controls an effect of said interference by providing a transmitter of the victim node with information enabling said transmitter to adjust its antenna pattern to minimize said interference effect.

23. The method of claim 2, wherein the dedicated node controls an effect of said interference by providing a transmitter of the victim node with information enabling said transmitter to adjust its scheduling in at least one of a time, a frequency and/or a space domain to minimize said interference effect.

24. The method of claim 2, wherein the dedicated node controls an effect of said interference by providing a receiver of the victim node with information enabling said receiver to adjust its antenna pattern to minimize said interference effects.

25. The method of claim 2, wherein the dedicated node controls an effect of said interference by providing a transmitter of the victim node with information enabling said transmitter to adjust at least one MAC coordination function parameter to ensure support of a required quality of service.

26. Apparatus for interference mitigation in a wireless network, said apparatus disposed at a dedicated node of said network responsible for addressing the interference within said network, the apparatus comprising apparatus configured to utilize an interference detection mechanism at said at least one dedicated node.

27. The apparatus of claim 26, further comprising:
logic configured to, if a victim node's reception and/or transmission are affected by one or more cells of the same network, implement an interference correction mechanism; and
apparatus for interference correction.

28. The apparatus of claim 27, wherein said apparatus for correction comprises apparatus configured to cause adjustment of one or more parameters of a transmitter of said one or more cells based at least in part on at least one of: (i) one or more interference measurements performed at the dedicated node, and/or (ii) the transmission requirements of the one or more cells.

29. The apparatus of claim 27, wherein said apparatus for correction comprises apparatus configured to cause adjustment of one or more of the transmitter parameters of a node that is then transmitting to the victim node based at least in part on at least one of (i) one or more interference measurements at the dedicated node, and/or (ii) transmission requirements of the transmitting node.

30. The apparatus of claim 27, wherein said apparatus for correction comprises apparatus configured to cause adjustment of one or more of said victim node's receiver parameters based at least in part on one or more interference measurements obtained at the dedicated node.

31. The apparatus of claim 30, wherein said one or more receiver parameters comprise one or more interference mitigation parameters.

32. The apparatus of claim 27, further comprising logic configured to, if a victim node's reception and/or transmission are affected by one or more entities not associated with said network, implement said interference correction mechanism.

33. The apparatus of claim 32, wherein said one or more entities not associated with said network comprise one or more interferers that emit electromagnetic radiation and are not associated with any network.

34. The apparatus of claim 32, wherein said one or more entities comprise one or more nodes of a network other than said network, said one or more nodes of said other network configured to implement a protocol that the dedicated node supports, and the interference correction mechanism comprises logic to cause adjustment of one or more transmitter parameters of the one or more nodes based at least in part on at least one of: (i) the interference measurements at the dedicated node, and/or (ii) transmission requirements of said one or more nodes.

35. An interference-mitigating wireless network architecture, comprising:
at least one dedicated node responsible for addressing the interference within said network;
at least one interference detection mechanism at said at least one dedicated node; and
an interference correction mechanism in communication with said at least one detection mechanism;
wherein said detection and correction mechanism cooperate to mitigate interference at a victim node within said network.
